(19) United States
(12) Patent Application Publication
(10) Pub. No.: US 2016/0286764 A1
(43) Pub. Date: Oct. 6, 2016

(54) Remote Controlled Animal Restraining Device

(71) Applicant: Jesse W. Clark, Bryant, AR (US)

(72) Inventor: Jesse W. Clark, Bryant, AR (US)

(21) Appl. No.: 15/083,880

(22) Filed: Mar. 29, 2016

Related U.S. Application Data
(60) Provisional application No. 62/178,082, filed on Mar. 30, 2015.

(51) Int. Cl. A01K 27/00

(52) U.S. Cl. CPC A01K 27/005; A01K 27/003

(57) ABSTRACT

A remote controlled electronic animal restraining device for tethering an animal to a fixed point. A buckle attached to the leash of an animal is inserted into an opening in the device housing where it is received by a locking system. The locking system engages the buckle until the user presses a button on a wireless remote, which causes the buckle to be released from the device housing. Once the buckle is released, the animal is free to move from the fixed point.

### CROSS-REFERENCE TO RELATED APPLICATIONS

This application claims the benefit of U.S. Provisional Patent Application No. 62/178,082, filed on Mar. 30, 2015, and entitled “E-Leash—Remote Controlled Electronic Quick-Release Leash.” Such application is incorporated herein by reference in its entirety.

### STATEMENT REGARDING FEDERALLY SPONSORED RESEARCH OR DEVELOPMENT

None

### BACKGROUND OF THE INVENTION

Hunting is a widely enjoyed pastime in the United States, with nearly 14 million people partaking in hunting annually. Migratory bird hunting accounts for about 19 percent of those 14 million hunters (or 2.6 million hunters annually), with duck hunting, in particular, accounting for 1.4 million hunters. A large number of hunters, particular those partaking in duck hunting, use hunting dogs to retrieve downed birds. These dogs are trained to stay in the duck blind until the hunter commands it to retrieve the downed birds. However, many hunting dogs, no matter how well trained, leave the blind looking for birds before the hunters command, which is dangerous for the dog, as guns are still being fired.

To solve this problem, hunters have developed techniques to keep the dog in the blind until the right time. For example, some hunters stand on the dog leash, preventing the dog from taking off before the hunter wishes. When the hunter is ready for the dog to retrieve birds, the hunter takes his legs off the lease and commands the dog to retrieve. Other hunters may wrap a dog leash around a tree and hook the dog to the leash. Although the dog is unable to release early, the problem with this technique is that the hunter must physically unhook the dog each time the dog is commanded to retrieve. This technique could also be potentially dangerous for the dog, as if the dog were to fall from the stand (which is often suspended above the ground) the dog would potentially be hung by the leash until the hunter as able to unhook the dog. The present invention is aimed at solving the inefficiencies of these techniques while still accomplishing the goal of having the dog secured until the hunter's command. Use of the hunting application is intended to be exemplary only and is not intended to limit the present invention as the present invention can be used in any application for which it is desirable to train a dog to learn to stay at a spot until they are given a command, such as police or military use.

### BRIEF SUMMARY OF THE INVENTION

The present invention relates generally to a device for securing a dog in a fixed place. An object of the present invention is to provide hunters with a safe and efficient means for securing their hunting dog to a tree, blind, or other immovable structure such that the dog remains in position until the hunter releases the dog and commands the dog to retrieve downed birds. It is understood that, although the preferred embodiment of the present invention is employed in hunting, the present invention can be used in any application in which it is desirable to secure a dog or other animal to a fixed point for a period of time prior to release. Furthermore, the device can be used in an application for which it is desirable to train a dog to learn to stay at a spot until they are given the command to break. For example, a police officer may use the device to release his K-9 officer from his police vehicle without requiring the officer to take his attention off of the perpetrator. Alternatively, a physically disabled dog owner can use the device to restrain their dog while doing a task in which the dog may get in the way (i.e. shutting a gate or door) and can release the dog remotely when the task is complete. Use of the hunting application is intended to be exemplary only and is not intended to limit the present invention to such application.

These and other features, objects and advantages of the disclosed subject matter will become better understood from a consideration of the following detailed description, drawings, and claims directed to the invention. This brief summary and the following detailed description and drawings are exemplary only, and are intended to provide further explanation of various implementations without limiting the scope of the invention as set forth in the claims.

### BRIEF DESCRIPTION OF THE DRAWINGS

FIG. 1 is a perspective view of the restraining device and the remote control of the preferred embodiment of the present invention.

FIG. 2A is a perspective view of the retraining device and the remote control of the preferred embodiment of the present invention and a dog with the leash of the present invention attached to the dog's collar

FIG. 2B is a schematic illustrating the step-by-step process (steps i, ii, iii, and iv) of the a dog being released from the restraining device of the preferred embodiment of the present invention.

FIG. 3 is an exploded view of the restraining device of the preferred embodiment of the present invention.

FIG. 4A is a perspective view of the locking and release system and power system of the preferred embodiment of the present invention.

FIG. 4B is a perspective view of the locking and release system and power system of the preferred embodiment of the present invention.

FIG. 4C is a perspective view of the remote control of the preferred embodiment of the present invention.

### DETAILED DESCRIPTION OF THE INVENTION

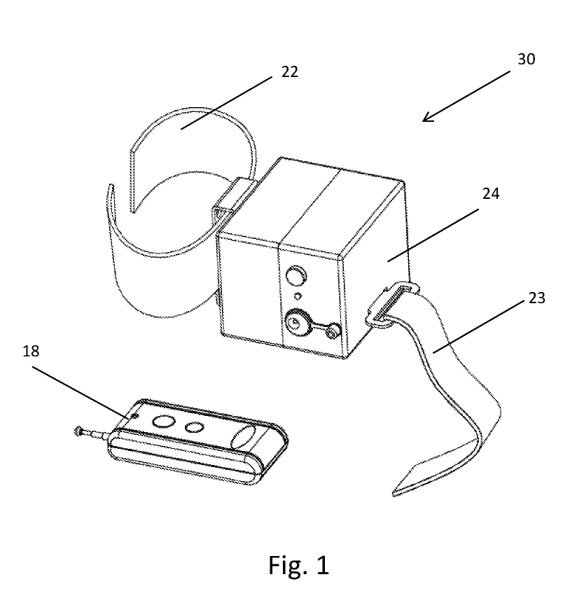

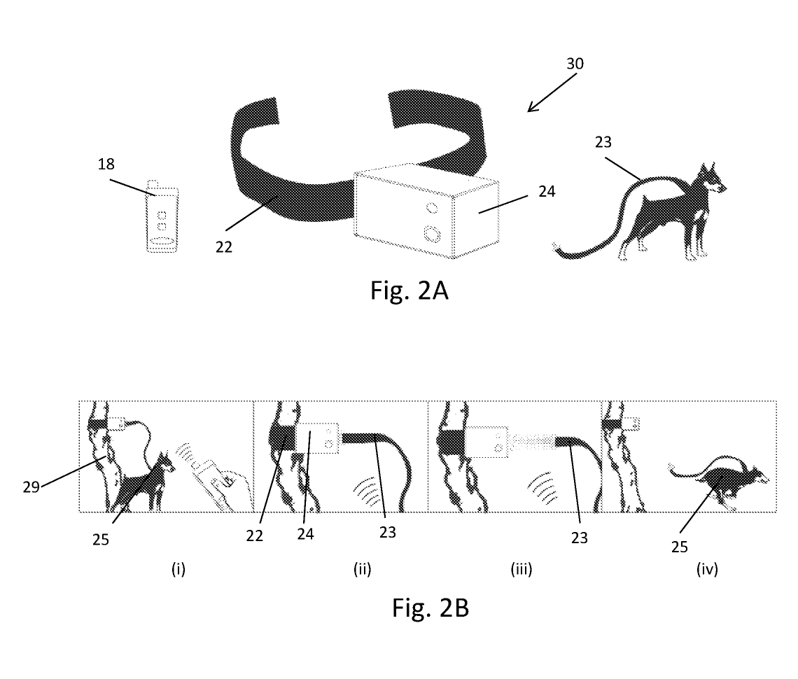

With reference to FIGS. 1-4C, the remote controlled electronic animal restraining device may be described. The present invention relates generally to a device for securing a dog in a fixed place. FIG. 1 and FIG. 2A shows the restraining device 30 and wireless remote 18 to operate the restraining device, which are described in detail below. Turning to FIG. 2B, the operation of the preferred embodiment of the present invention can be described generally. A tethering strap 22 of the restraining device 30 is removably attached to a tree or other stationary structure 29. The strap 22 is attached to the shell or housing 24, which contains the internal components of the device. A leash 23 is attached to a collar 25 worn by the dog. For example, the leash 23 and the collar 25 may be woven together or join in any other way that would be well-known to those skilled in the art. The leash 23 attached to the dog can be ejected from the shell 24 attached to the tree 29 by the push of a button 28 on the wireless remote 18. This action frees the dog from the stationary structure 29, allowing the dog to retrieve the downed birds or carry out any other desired task.

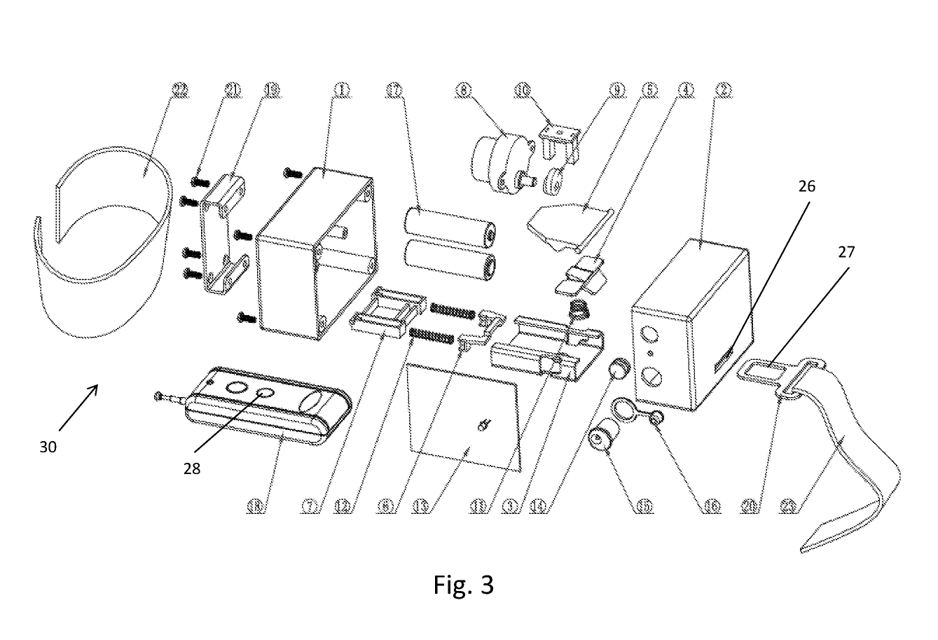

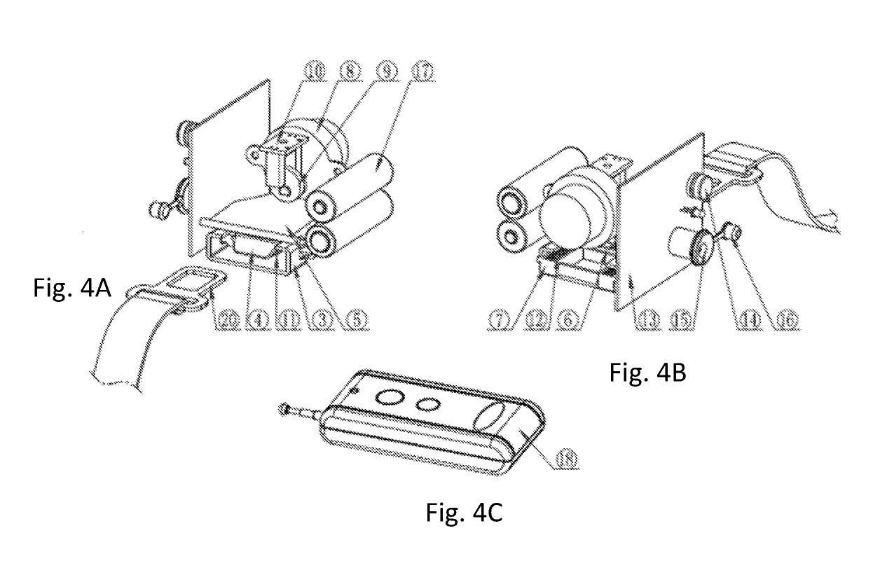

Now, turning to FIGS. 3 and 4A-4B, the restraining device of the present invention can be described in detail. The restraining device includes a body shell 24 that houses the locking and release system and the power system described below. The body shell comprises two pieces 1, 2 that are attached by fasteners 21, such as screws, to form a hollow housing in which the constituent components are enclosed. One body piece 1 is attached to the tethering strap 22, which removably attaches the restraining device to a fixed point 29, such as a tree. For example, the tethering strap 22 may be a ratchet strap that can be placed around a fixed object and the slack in the strap 22 removed. However, it should be understood that the tethering strap 22 may be any type of rope or webbing suitable to secure the device in the place that would be well-known to those skilled in the art. In the preferred embodiment, a metal bracket 19 is used to attach the body piece 1 to the tethering strap 22. The tethering strap 22 may be wrapped around the recessed portion of the metal bracket 19, which in turn is attached to the housing 1 via fasteners 21. The other body piece 2 has a slot opening 26 configured to receive a removable buckle 20 attached to one end of a dog leash 23.

A locking and release system of the restraining device includes the locking system bracket 3, locking system lock 4, locking system unlock plate 5, and release spring 11, buckle ejector 6, release spring housing 7, and eject spring 12. The restraining device also includes a power system that includes a motor 8, gear 9, switch 10, power control board 13, power switch 14, and batteries 17. These components work together in the functioning of the restraining device, as described below.

The locking system inside the body shell 24 operates to receive and secure the removable buckle 20 once the buckle 20 inserted into the slot opening 26. The buckle 20 is attached to one end of the leash 23 while the other end of the leash attaches to the collar of the dog or other animal that the users wants to tether to a fixed object. As shown in FIG. 3 and FIGS. 4A-4B, the release spring housing 7 fits securely into the locking system bracket 3, keeping the eject spring 12 under pressure against the buckle ejector 6 at all times. When the buckle 20 is inserted into the slot opening 26 in the body shell, the buckle 20 is forced to be aligned with the buckle ejector 6. This alignment is kept using the tabs on the locking system bracket 3. As the removable buckle 20 continues to slide into the device, the eject spring 12 becomes more compressed (i.e. shorter in length).

When the removable buckle 20 is inserted far enough into the locking system bracket 3, the locking system lock 4 is pushed into the opening 27 in the buckle 20. This is because the eject spring 12 is pushing on the locking system lock 4 to keep it held in position. This causes the system to be locked. When the buckle 20 is locked into the restraining device 30, the animal is prohibited from moving away from the fixed point. The buckle 20 will remain locked until the device is powered on and the user presses a button 28 on the wireless remote 18, which in turn, communicates with the power system of the device 30 that results in release of the buckle from the device.

The buckle release process is driven by the power system of the restraining device. Once the device is powered on by the user by pressing the on/off switch 14 on the body shell, power is provided by batteries 17 or another on board power supply source. When the button 28 on the wireless remote is pressed, a signal is generated through the remote and is received in a power control board 13 housed in the body shell 24. The gear 9 is securely attached to the end of the motor 8. When button 28 is pressed, the power system powers the motor 8 to rotate the gear 9. The removable buckle 20 cannot be removed until the locking system unlock plate 5 is pressed in the direction of the locking system bracket 3 by the gear. When the locking system unlock plate 5 has deflected far enough, it will depress the locking system lock 4, allowing the removable buckle 20 to be removed from the device. Pressure applied to the locking system unlock plate 5 will cause the removable buckle 20 to be ejected from the device due to the force exerted from the eject spring 12 pushing against the locking system lock 4.

When the switch 14 or the button 28 is released, the motor 8 will disengage power and the gear 9 will be free to rotate back to a more comfortable position, allowing the locking system unlock plate 5 to raise back to the ready position, due to the pressure exerted upon it by the release spring 11. Alternatively, if the gear 9 contacts the switch 10, the motor 8 automatically stops. At this point, the system has been “reset” allowing the whole process to be repeated. Once the dog returns, the user may reinsert the removable buckle into the restraining device, which will lock the buckle 20 back into the locking assembly. The process may then be repeated as necessary.

The exterior surface of body shell includes the power on/off switch 14 and rechargeable socket 15. Because repeated use of the device may deplete the power source, a rechargeable socket 15 may be coupled to the device to allow recharging of the batteries 17 or other power supply. A rubber seal 16 is coupled to the rechargeable socket 15 to keep any moisture from reaching the internal components of the power system.

While the locking and release system of the present invention has been described in detail above, it should be understood that other locking and release systems that would be well-known to those skilled in the art may alternatively be used that can carry out the same function described above.

The present invention has been described with reference to the foregoing specific implementations. These implementations are intended to be exemplary only, and not limiting to the full scope of the present invention. Many variations and modifications are possible in view of the above teachings. The invention is intended to be limited only as set forth in the appended claims.

1. A remote controlled animal restraining device, comprising:
(a) a leash having a first end and a second end, wherein said first end of said leash comprises a buckle;
(b) a housing having an exterior surface, wherein said exterior surface comprises an opening configured to receive said buckle;
(c) a locking system positioned inside said housing, wherein said locking system is configured to hold in place said buckle inside said housing;
(d) a release system positioned inside said housing, wherein said release system is configured to release said buckle from housing;
(e) a power system in communication with said release system; and
(f) a remote control in communication with said power system, wherein said remote control is configured to activate said power system.

2. The remote controlled animal restraining device of claim 1, wherein said buckle comprises an opening.

3. The remote controlled animal restraining device of claim 1, wherein said second end of said leash is attached to an animal collar.

4. The remote controlled animal restraining device of claim 1, wherein a strap is mounted to said exterior surface of said housing.

5. The remote controlled animal restraining device of claim 4, wherein said strap is configured to be attached to a fixed object.

6. The remote controlled animal restraining device of claim 2, wherein said locking system comprises a lip that is configured to be received in said opening of said buckle.

7. The remote controlled animal restraining device of claim 1, wherein said power system comprises a power source.

8. The remote controlled animal restraining device of claim 7, wherein said power source is a battery.

9. The remote controlled animal restraining device of claim 1, wherein said power system comprises a power control board configured to receive a signal from said remote control.

10. The remote controlled animal restraining device of claim 1, wherein said power system comprises a motor.

11. The remote controlled animal restraining device of claim 9, wherein a gear is connected to said motor.

12. The remote controlled animal restraining device of claim 10, wherein said gear is in communication with said release system.
